(19) United States
(12) Patent Application Publication
(10) Pub. No.: US 2019/0346025 A1
(43) Pub. Date: Nov. 14, 2019

(54) Transmission for a Motor Vehicle

(71) Applicant: ZF Friedrichshafen AG, Friedrichshafen (DE)

(72) Inventors: Peter Ziemer, Tettnang (DE); Martin Brehmer, Tettnang (DE); Leschek Debernitz, Eriskirch (DE); Oliver Bayer, Lindau (DE); Fabian Kutter, Kressbronn (DE); Christian Michel, Ravensburg (DE)

(21) Appl. No.: 16/461,528

(22) PCT Filed: Oct. 24, 2017
(86) PCT No.: PCT/EP2017/077117

§ 371 Date: May 16, 2019

(30) Foreign Application Priority Data
Nov. 22, 2016 (DE) 10 2016 223 013.1

(51) Int. Cl. F16H 3/66; F16H 57/10

(52) U.S. Cl. CPC F16H 3/66; F16H 2003/442; F16H 57/10

(57) ABSTRACT

A transmission for a motor vehicle has a transversely oriented drive train, a first planetary gear set, a second planetary gear set, a first brake, a first clutch, and a second clutch. The first clutch is operatively connected to a first element of the first planetary gear set, the second clutch is operatively connected to at least one element of the second planetary gear set, and the first brake is operatively connected to a second element of the first planetary gear set. The first and second clutches are axially between the first and second planetary gear sets and directly next to each other, with the second clutch being directly adjacent to the second planetary gear set. The first planetary gear set is axially furthest from a face end of the transmission having a transmission-external drive unit interface. The first brake is at least partially radially outside the second clutch.

### FIELD OF THE INVENTION

The invention relates generally to a transmission for a motor vehicle, and to a drive train for a motor vehicle having such a transmission. In this case, a transmission refers, in particular, to a multi-stage transmission, in which a multitude of gears, i.e., fixed transmission ratios between the input shaft and the output shaft of the transmission, are preferably automatically engageable with the aid of shift elements. In this case, the shift elements are clutches or brakes, for example. Such transmissions are utilized primarily in motor vehicles in order to adapt the rotational speed and torque output characteristic of the drive unit to the driving resistances of the vehicle in a suitable way.

### BACKGROUND

Patent application DE 10 2005 014 592 A1, which belongs to the applicant, describes numerous variants of a multi-stage transmission for a vehicle including a prime mover or motor, which is installed transversely to the direction of travel, and an input shaft and an output shaft, which are arranged axially parallel to each other. The axial installation length of this type of transmission is to be kept as short as possible, since the installation space available in the vehicle is limited between the motor and the body, or the chassis. The disclosed variants describe various arrangements of the transmission components for achieving this goal. The multi-stage transmission has an essentially rectangular cross-section, i.e., an essentially constant diameter along the axial installation length of the multi-stage transmission.

The installation space available in the motor vehicle for such a transmission is frequently limited on the side of the transmission facing away from the motor by a structural longitudinal member of the motor vehicle, which is configured, for example, for accommodating chassis components and/or a crash box of the motor vehicle. Depending on the configuration of the motor vehicle, sections of a transmission are arranged below such a longitudinal member, provided the outer diameter of the transmission is kept small in this area.

The problem addressed by the invention is therefore that of providing a transmission which makes the best possible use of the installation space available in the motor vehicle.

### SUMMARY OF THE INVENTION

The transmission includes at least two planetary gear sets, at least one brake, and at least two clutches. The at least two planetary gear sets are utilized for implementing gears, i.e., fixed transmission ratios between an input shaft and an output shaft of the transmission. The at least two clutches operate as shift elements, the selective actuation of which connects elements of the at least two planetary gear sets to each other or to the input shaft in order to implement gears. The at least one brake also operates as a shift element, the selective actuation of which rotationally fixes one or more of the at least two planetary gear set elements in order to implement gears.

A first clutch of the at least two clutches is operatively connected to a first element of a first planetary gear set of the at least two planetary gear sets. A second clutch of the at least two clutches is operatively connected to at least one element of a second planetary gear set of the at least two planetary gear sets. A first brake of the at least one brake is operatively connected to a second element of the first planetary gear set. In this context, an operative connection is understood to be a permanently rotationally fixed connection between the particular planetary gear set element and a shift-element half of the particular clutch, or the brake.

The first and the second clutches are arranged axially between the first and the second planetary gear sets. The second clutch is arranged axially directly adjacent to the second planetary gear set. Of all the gear-implementing planetary gear sets of the transmission, the first planetary gear set has the greatest axial distance from a face end of the transmission that includes an interface for connecting the transmission to a transmission-external drive unit, i.e., for example, an internal combustion engine. The first planetary gear set is therefore arranged on the axial end of the transmission that faces away from the transmission-external drive unit.

According to the invention, the first and the second clutches are arranged axially directly next to each other, wherein the first brake is arranged, at least in sections, radially outside the second clutch. The two shift elements operatively connected to the first planetary gear set, i.e., the first brake and the first clutch, are therefore arranged upstream from the first planetary gear set in the axial direction. The arrangement of the first and second clutches directly next to each other allows for a radially compact embodiment, so that the first brake is arranged, at least in sections, radially outside the second clutch. This makes it possible to reduce the transmission cross-section in the direction of the side of the transmission facing away from the drive unit, starting from a cross-sectional plane which contains elements of the second clutch and the first brake.

Preferably, the first clutch is arranged axially directly adjacent to the first planetary gear set via an intermediate connection of at least one shaft section. An actuating element of the first clutch, for example, a piston, is considered to be an integral part of the first clutch in this case. In other words, no other transmission component except for the at least one shaft section is located axially between the first planetary gear set and the first clutch, which facilitates an axially compact version of the transmission.

Preferably, the first and the second clutches are force-locking lamellar shift elements which are actuatable with the aid of hydraulically displaceable pistons. According to one preferred embodiment, the outer disk carriers of the first and second clutches are permanently connected to each other in a rotationally fixed manner, particularly preferably by a one-piece embodiment of the outer disk carriers. This facilitates an axially compact version of the first and the second clutches.

Preferably, a first piston for actuating the first clutch is axially displaceably guided on an inner disk carrier of the first clutch, and a second piston for actuating the second clutch is axially displaceably guided on an inner disk carrier of the second clutch. This embodiment as well facilitates an axially compact version of the first and the second clutches.

According to one preferred embodiment, the inner disk carrier of the first clutch directly abuts the inner disk carrier of the second clutch via an intermediate connection of an axial bearing. Via the axial bearing, an axial force acting on the inner disk carrier of the second clutch is transmittable to the inner disk carrier of the first clutch. This embodiment additionally facilitates an axially compact version of the first and the second clutches.

According to one preferred embodiment, a pressurization of the second piston for actuating the second clutch results in an axial displacement of the second piston in the direction of the second planetary gear set. In the same way, a pressurization of the first piston for actuating the first clutch results in an axial displacement of the first piston preferably in the direction of the second planetary gear set. Such an embodiment facilitates an axially compact version of the first and the second clutches.

Preferably, the first brake is a force-locking lamellar shift element, wherein a further piston for actuating the first brake is arranged, at least in sections, radially outside the second planetary gear set. It is particularly preferred that the further piston is arranged completely axially next to the first brake. In other words, no section of the further piston is arranged radially outside or radially within the first brake. Such an embodiment facilitates an axially compact version of the transmission.

According to one preferred embodiment, an inner disk carrier of the first brake is permanently rotationally fixed to or formed integrally with a shaft utilized for the permanent, rotationally fixed connection between the inner disk carrier of the first brake and the second element of the first planetary gear set, and is mounted directly on the input shaft of the transmission via a plain bearing. This results in a simple and efficient centering of the inner disk carrier of the first brake. Due to the utilization of a plain bearing, the diameter of the first planetary gear set can also be kept small, and so the installation space requirement of the transmission in this area is kept particularly compact.

Preferably, the first element of the first planetary gear set is mounted directly on a section of the shaft via a plain bearing. This also facilitates a compact embodiment of the transmission.

Preferably, the shaft is made from aluminum via pressure die casting. As a result, a particularly installation-space-saving shaping of the shaft is achieved with little outlay.

According to one preferred embodiment, a section of a connecting shaft is arranged spatially between the first brake and the second clutch and is configured for continuously transmitting torque between a third element of the first planetary gear set and an element of a third, gear-implementing planetary gear set of the transmission. The third planetary gear set of the gear-implementing planetary gear sets has the shortest axial distance to the face end of the transmission that has the interface to the transmission-external drive unit.

Preferably, the transmission includes a fourth gear-implementing planetary gear set which is arranged radially within the second planetary gear set. A ring gear of the fourth planetary gear set and a sun gear of the second planetary gear set are formed together as one piece in this case.

Preferably, the first planetary gear set is a minus gear set. A minus gear set refers to a planetary gear set including a carrier, on which the planetary gears are rotatably mounted, and including a sun gear and a ring gear, wherein the tooth system of at least one of the planetary gears intermeshes both with the tooth system of the sun gear and with the tooth system of the ring gear, whereby the ring gear and the sun gear rotate in opposite directions of rotation when the sun gear rotates while the carrier is held. The first element is preferably formed by the sun gear, and the second element is preferably formed by the ring gear of the first planetary gear set.

According to one preferred embodiment, the transmission includes an electric machine or motor, the rotor of which is permanently or engageably connected to at least one element of the gear-implementing planetary gear sets. Due to the electric machine, the transmission is suitable for use in a hybrid vehicle. The permanent or engageable connection of the rotor to a planetary gear set element permits the motor vehicle to be driven with the aid of the electric machine at least in selected gear steps of the transmission. According to one preferred embodiment, the electric machine is arranged axially parallel to the gear-implementing planetary gear sets. The permanent or engageable connection between the rotor and the planetary gear set element occurs, for example, via a single-stage or multi-stage spur gear drive or via a chain drive. The axially offset arrangement permits an axially compact embodiment of the transmission.

The transmission is an integral part of a drive train of a motor vehicle. The drive train includes, in addition to the transmission, an internal combustion engine which is torsionally elastically connected or is able to be torsionally elastically connected to the input shaft of the transmission via a torsional damper. The output shaft of the transmission is drivingly operatively connected to a transmission-internal or transmission-external differential gear which is operatively connected to wheels of the motor vehicle. If the transmission includes the electric machine, the drive train allows for multiple drive modes of the motor vehicle. In an electric mode, the motor vehicle is driven by the electric machine of the transmission. In an internal combustion engine-operated mode, the motor vehicle is driven by the internal combustion engine. In a hybrid mode, the motor vehicle is driven by the internal combustion engine as well as by the electric machine of the transmission.

A permanent connection is referred to as a connection that always exists between two elements. Elements which are permanently connected in such a way always rotate with the same dependence between their speeds. No shift element may be located in a permanent connection between two elements. A permanent connection is therefore to be distinguished from an engageable connection. A permanently rotationally fixed connection is referred to as a connection that always exists between two elements and, therefore, the connected elements in the connection always have the same rotational speed.

### BRIEF DESCRIPTION OF THE DRAWINGS

One exemplary embodiment of the invention is described in detail in the following with reference to the attached figures. Wherein:

FIG. 1 shows a schematic view of a transmission according to the invention;

FIG. 2 shows a section view of the transmission according to the invention; and

FIG. 3 shows a diagrammatic view of a motor vehicle drive train.

The proportions represented in the figures have been selected merely by way of example and are to be only qualitatively evaluated. They provide no information regarding preferred transmission ratios.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

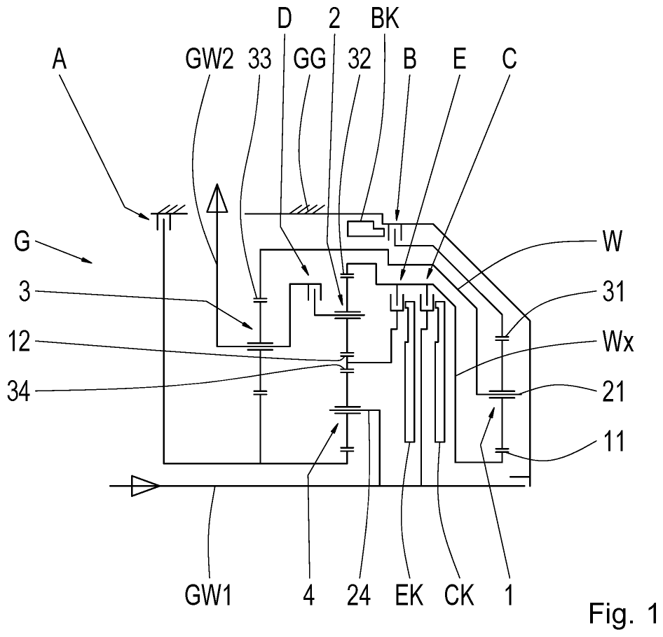

FIG. 1 shows a schematic view of a transmission G according to the invention. The transmission G includes an input shaft GW1, an output shaft GW2, and four planetary gear sets including a first planetary gear set 1, a second planetary gear set 2, a third planetary gear set 3, and a fourth planetary gear set 4. The fourth planetary gear set 4 is arranged radially within the second planetary gear set 2. The first, second, third, and fourth planetary gear sets 1, 2, 3, 4 are all minus gear sets.

The left side of the transmission G in FIG. 1 faces the face end of the transmission G that includes an interface to a transmission-external drive unit which is not represented in FIG. 1. The third planetary gear set 3 has the shortest axial distance of the four planetary gear sets 1, 2, 3, 4 to the face end, while the first planetary gear set 1 has the greatest axial distance of the four planetary gear sets 1, 2, 3, 4 to the face end. The second planetary gear set 2 and the fourth planetary gear set 4 are arranged axially between the third planetary gear set 3 and the first planetary gear set 1 in a common gear set plane.

A sun gear of the third planetary gear set 3 is permanently rotationally fixed to a sun gear of the fourth planetary gear set 4. A carrier of the third planetary gear set 3 is permanently rotationally fixed to the output shaft GW2. A ring gear of the third planetary gear set 3 is permanently rotationally fixed to a carrier 21 of the first planetary gear set 1 via a connecting shaft W. A carrier 24 of the fourth planetary gear set 4 is permanently rotationally fixed to the input shaft GW1. A ring gear 32 of the second planetary gear set 2 is permanently rotationally fixed to a sun gear 11 of the first planetary gear set 1. A ring gear 34 of the fourth planetary gear set 4 and a sun gear 12 of the second planetary gear set 2 are formed together one piece.

The transmission G includes five shift elements including a first brake B, a second brake A, a first clutch C, a second clutch E, and a third clutch D. By engaging the first brake B, a ring gear 31 of the first planetary gear set 1 is rotationally fixed to a housing GG of the transmission G. The first brake B is therefore operatively connected to the ring gear 31. By engaging the second brake A, the interconnected sun gears of the third planetary gear set 3 and the fourth planetary gear set 4 are rotationally fixed. By engaging the first clutch C, the input shaft GW1 is connected to the ring gear 32 of the second planetary gear set 2 and to the sun gear 11 of the first planetary gear set 1—which is connected to the ring gear 32 of the second planetary gear set 2. The first clutch C is therefore operatively connected to the sun gear 11. By engaging the second clutch E, the sun gear 12 of the second planetary gear set 2 is connected to the ring gear 32 of the second planetary gear set 2. The second clutch E is therefore operatively connected to two elements of the second planetary gear set 2. By engaging the third clutch D, the carrier of the third planetary gear set 3 is connected to the carrier of the second planetary gear set 2.

With the aid of the four planetary gear sets 1, 2, 3, 4 and by selectively engaging the first and second brakes B, A and the first, second, and third clutches C, E, D, multiple transmission ratios between the input shaft GW1 and the output shaft GW2 are implementable. The four planetary gear sets 1, 2, 3, 4 therefore contribute to the gear implementation of the transmission G.

The first clutch C and the second clutch E are arranged axially between the second planetary gear set 2 and the first planetary gear set 1. The second clutch E is arranged axially directly adjacent to the second planetary gear set 2. The first clutch C is arranged axially directly next to the second clutch E. The first clutch C, except for a shaft section Wx, is arranged axially directly adjacent to the first planetary gear set 1. The shaft section Wx is an integral part of the operative connection between the first clutch C and the sun gear 11. The first brake B is arranged, in sections, radially outside the second clutch E. In other words, elements of the first brake B and elements of the second clutch E are arranged in a common plane which is aligned at a right angle to the axis of rotation of the input shaft.

The first and second brakes B, A as well as the first, second, and third clutches C, E, D are preferably force-locking lamellar shift elements which are actuatable via hydraulically displaceable pistons. This is to be considered merely as an example. Alternatively, individual ones of the shift elements B, A, C, D, E are form-locking shift elements.

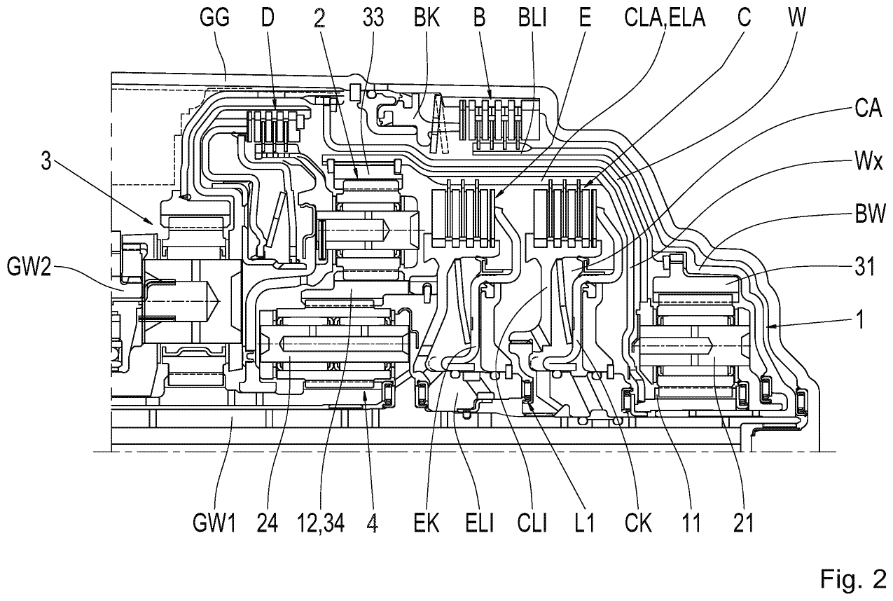

FIG. 2 shows a section view of the transmission G according to the invention. An outer disk carrier CLA of the first clutch C is formed integrally with an outer disk carrier ELA of the second clutch E. A first piston CK for actuating the first clutch C is axially displaceably guided on the inner disk carrier CLI of the first clutch C, wherein the first clutch C is engaged by moving the first piston CK toward the left in the view shown. A second piston EK for actuating the second clutch E is axially displaceably guided on the inner disk carrier ELI of the second clutch E, wherein the second clutch E is engaged by moving the second piston EK toward the left in the view shown. A further piston BK for actuating the first brake B is arranged completely axially next to the first brake B and, at least in sections, radially outside the second planetary gear set 2. The first brake B is engaged by moving the further piston BK toward the right in the view shown. A further outer disk carrier of the first brake B is formed directly on the housing GG of the transmission G.

The inner disk carrier CLI of the first clutch C directly abuts the inner disk carrier ELI of the second clutch E via an intermediate connection of an axial antifriction bearing L1. An oil path for filling a pressure compensating cavity CA of the first clutch C extends through the inner disk carrier CLI of the first clutch C.

An inner disk carrier BLI of the first brake B is formed integrally with a shaft BW. The shaft BW is utilized for the permanently rotationally fixed connection between the ring gear 31 of the first planetary gear set 1 and the first brake B, wherein the shaft BW is mounted directly on the input shaft GW1 via a plain bearing. The sun gear 11 of the first planetary gear set 1 is mounted directly on a section of the shaft BW via a further plain bearing.

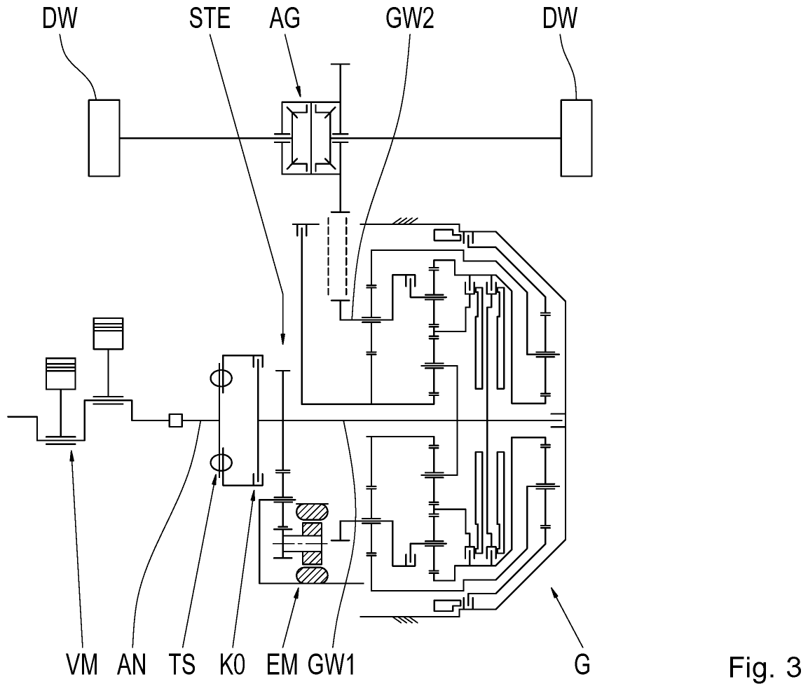

FIG. 3 shows a diagrammatic view of a motor vehicle drive train including the transmission G according to the invention. The transmission G now additionally includes a connection shaft AN, a separating clutch KO, a multi-stage spur gear train STE, and an electric machine EM. The connection shaft AN is connected to the input shaft GW1 by engaging the separating clutch KO. The connection shaft AN includes two sections which are connected to each other by a torsional damper TS. The electric machine EM is arranged axially parallel to the four planetary gear sets 1, 2, 3, 4. The rotor of the electric machine EM is permanently connected to the carrier 24 of the fourth planetary gear set 4 via the spur gear train STE and via the input shaft GW1.

The connection shaft AN acts as a torque-transmitting interface to an internal combustion engine VM which forms the transmission-external drive unit. The output shaft GW2 is connected, via an indicated torque-transmitting connection, to the ring gear of a differential gear AG which distributes the power of the output shaft GW2 to driving wheels DW of the motor vehicle.

In FIG. 3, both section halves of the transmission G are represented, while only one section half is shown in the representations in FIG. 1 and FIG. 2. This reduced representation serves to improve clarity, while the representation in FIG. 3 is intended to illustrate the center distances between the electric machine EM, the four planetary gear sets 1, 2, 3, 4, and the differential gear AG. The representation selected in FIG. 3, including the electric machine EM, the four planetary gear sets 1, 2, 3, 4, and the differential gear AG in a common cutting plane, is to be considered merely as an example. In fact, the spatial arrangement of the electric machine EM, the four planetary gear sets 1, 2, 3, 4, and the differential gear AG are preferably selected in such a way that a common cutting plane is not possible. As a result, a particularly compact configuration of the transmission G is possible.

The arrangement of the transmission components shown in the figures allows for an advantageously sloping outer contour of the transmission housing GG. As a result, the best possible use is made of the installation space available in the motor vehicle.

Modifications and variations can be made to the embodiments illustrated or described herein without departing from the scope and spirit of the invention as set forth in the appended claims.

Reference characters

| | |
|---|---|
| G | transmission |
| GW1 | input shaft |
| GW2 | output shaft |
| 1 | first planetary gear set |
| 11 | sun gear of the first planetary gear set |
| 21 | carrier of the first planetary gear set |
| 31 | ring gear of the first planetary gear set |
| 2 | second planetary gear set |
| 12 | sun gear of the second planetary gear set |
| 32 | ring gear of the second planetary gear set |
| 3 | third planetary gear set |
| 33 | ring gear of the third planetary gear set |
| 4 | fourth planetary gear set |
| 24 | carrier of the fourth planetary gear set |
| 34 | ring gear of the fourth planetary gear set |
| B | first brake |
| BK | further piston |
| BLI | inner disk carrier of the first brake |
| A | second brake |
| C | first clutch |
| CK | first piston |
| CLA | outer disk carrier of the first clutch |
| CLI | inner disk carrier of the first clutch |
| CA | pressure compensation space |
| E | second clutch |
| ELA | outer disk carrier of the second clutch |
| ELI | inner disk carrier of the second clutch |
| EK | second piston |
| D | third clutch |
| L1 | axial bearing |
| BW | shaft |
| W | connecting shaft |
| Wx | shaft section |
| EM | electric machine |
| STE | spur gear stage |
| AN | connection shaft |
| K0 | separating clutch |
| TS | torsional damper |
| DW | driving wheel |
| AG | differential gear |
| VM | internal combustion engine |

1-20. (canceled)

21. A transmission (G) for a motor vehicle, comprising:
a drive train oriented transversely to a direction of travel of the motor vehicle;
a first planetary gear set (1) and a second planetary gear set (2);
a brake (B);
a first clutch (C) and a second clutch (E); and
a face end comprising an interface for connecting the transmission (G) to a transmission-external drive unit (VM),
wherein the first clutch (C) is operatively connected to a first element (11) of the first planetary gear set (1), the second clutch (E) is operatively connected to at least one element (12, 32) of the second planetary gear set (2), and the brake (B) is operatively connected to a second element (31) of the first planetary gear set (1),
wherein the first clutch (C) and the second clutch (E) are arranged axially between the first planetary gear set (1) and the second planetary gear set (2),
wherein the second clutch (E) is arranged axially directly adjacent the second planetary gear set (2),
wherein, of the first and second planetary gear sets (1, 2, 3, 4), the first planetary gear set (1) has the greatest axial distance from the face end,
wherein the first clutch (C) and the second clutch (E) are arranged axially directly next to each other, and
wherein the brake (B) is arranged, at least partially, radially outside the second clutch (E).

22. The transmission (G) of claim 21, wherein the first clutch (C) is arranged axially directly adjacent the first planetary gear set (1) via an intermediate connection of at least one shaft section (Wx).

23. The transmission (G) of claim 21, wherein the first clutch (C) and the second clutch (E) are friction-locking lamellar shift elements, the first clutch (C) being actuatable by a first piston (CK) and the second clutch (E) being actuatable by a second piston (EK), the first and second pistons (CK, EK) being hydraulically displaceable.

24. The transmission (G) of claim 23, wherein an outer disk carrier (CLA) of the first clutch (C) and an outer disk carrier (ELA) of the second clutch (E) are permanently connected to each other in a rotationally fixed manner.

25. The transmission (G) of claim 24, wherein the outer disk carriers (CLA, ELA) of the first and second clutches (C, E) are formed as one piece.

26. The transmission (G) of claim 23, wherein the first piston (CK) for actuating the first clutch (C) is axially displaceably guided on an inner disk carrier (CLI) of the first clutch (C) and the second piston (EK) for actuating the second clutch (E) is axially displaceably guided on an inner disk carrier (ELI) of the second clutch (E).

27. The transmission (G) of claim 26, wherein the inner disk carriers (CLI, ELI) of the first and second clutches (C, E) directly abut each other via an intermediate connection of an axial bearing (L1).

28. The transmission (G) of claim 23, wherein a pressurization of the second piston (EK) in order to engage the second clutch (E) brings about an axial displacement of the second piston (EK) in the direction of the second planetary gear set (2).

29. The transmission (G) of claim 23, wherein a pressurization of the first piston (CK) in order to engage the first clutch (C) brings about an axial displacement of the first piston (CK) in the direction of the second planetary gear set (2).

30. The transmission (G) of claim 21, wherein the brake (B) is a friction-locking lamellar shift element, and a further piston (BK) for actuating the brake (B) is arranged, at least partially, radially outside the second planetary gear set (2).

31. The transmission (G) of claim 30, wherein the further piston (BK) for actuating the brake (B) is arranged completely axially next to the brake (B).

32. The transmission (G) of claim 30, wherein an inner disk carrier (BLI) of the brake (B) is permanently rotationally fixed to or is formed integrally with a shaft (BW), the shaft (BW) being configured for the permanently rotationally fixed connection between the second element (31) of the first planetary gear set (1) and the brake (B), wherein the shaft (BW) is mounted directly on an input shaft (GW1) of the transmission (G) via a bearing.

33. The transmission (G) of claim 32, wherein the first element (11) of the first planetary gear set (1) is mounted directly on a section of the shaft (BW) via another bearing.

34. The transmission (G) of claim 32, wherein shaft (BW) is an aluminum die cast part.

35. The transmission (G) of claim 21, further comprising a third planetary gear set (3), wherein a section of a connecting shaft (W) is arranged between the brake (B) and the second clutch (E) and is configured for continuously transmitting torque between a third element (21) of the first planetary gear set (1) and an element (33) of the third planetary gear set (3), wherein, of all of the planetary gear sets (1, 2, 3, 4) of the transmission (G), the third planetary gear set (3) has the shortest axial distance from the face end.

36. The transmission (G) of claim 21, further comprising a fourth planetary gear set (4), wherein the fourth planetary gear set (4) is arranged radially within the second planetary gear set (2), and a ring gear (34) of the fourth planetary gear set (4) and a sun gear (12) of the second planetary gear set (2) are formed as one piece.

37. The transmission (G) of claim 21, wherein the first planetary gear set (1) is a minus gear set, the first element (11) of the first planetary gear set (1) is a sun gear, and the second element (31) of the first planetary gear set (1) is a ring gear.

38. The transmission (G) of claim 21, further comprising an electric machine (EM), wherein a rotor of the electric machine is permanently or engageably connected to at least one element (24) of one of the first and second planetary gear sets (1, 2, 3, 4).

39. The transmission (G) of claim 38, wherein the electric machine (EM) is arranged axially parallel to the planetary gear sets (1, 2, 3, 4) of the transmission (G).

40. A drive train for a motor vehicle comprising the transmission (G) of claim 21.
